(19) United States
(12) Patent Application Publication
(10) Pub. No.: US 2016/0003700 A1
(43) Pub. Date: Jan. 7, 2016

(54) Pressure measurement cell having an installation assembly

(71) Applicant: VEGA GRIESHABER KG, Wolfach (DE)

(72) Inventor: Joern JACOB, Wolfach (DE)

(21) Appl. No.: 14/758,630

(22) PCT Filed: Mar. 25, 2014
(86) PCT No.: PCT/EP2014/055973

§ 371 Date: Jun. 30, 2015

(30) Foreign Application Priority Data
Mar. 25, 2013 (EP) 13160842.4

(51) Int. Cl. G01L 19/14

(52) U.S. Cl. CPC G01L 19/14

(57) ABSTRACT

The invention relates to a pressure measurement cell, which has an installation assembly. The installation assembly has a metal bottom and a peripheral metal wall. The pressure measurement cell has a measurement membrane on the front side, which measurement membrane is arranged at the bottom in the installation assembly.

### CROSS REFERENCE TO RELATED APPLICATIONS

This patent application claims priority to International Patent Application PCT/EP2014/055973, filed on Mar. 25, 2014, and thereby to European Patent Application 13160842.4, filed on Mar. 25, 2013.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to a pressure measurement cell having an installation assembly.

2. Background of the Invention

Pressure measuring cells with installation assemblies are known from prior art, with it being common in prior art to radially grasp the pressure measuring cell and to seal it via radially provided gaskets towards a process environment located in the front of the pressure measuring cell. In particular, in the chemical and pharmaceutical industry, but also in the food sector, major expenses are needed to ensure a connection of the pressure measuring cell to the processing environment free from any gaps and sufficiently sealed. Here it is considered disadvantageous on the one hand, that the embodiments known from prior art cannot be embodied in a lastingly sealed fashion with regard to their tightness, due to thermal effects as well as based on corrosion and/or aging of the sealing materials used. Additionally it is considered disadvantageous that the arrangements known from prior art are not diffusion tight and thus diffusion of components from the processing environment in the direction towards the pressure measuring cell cannot be prevented. Additionally, using the various connections known from the technology of prior art, it is possible only with great expense to achieve a connection of the pressure measuring cell to the processing environment free from any gaps.

The objective of the present invention is to provide a pressure measuring cell with an installation assembly which is free from the disadvantages of prior art.

This objective is attained in a pressure measuring cell with the installation assembly comprising the features as described herein.

### BRIEF SUMMARY OF THE INVENTION

In a preferred embodiment, a pressure measuring cell (1) comprising an installation assembly (3) with a metal bottom and a circumferential metal wall (33), with the pressure measuring cell (1) at the front side comprising a measuring membrane (11), which is arranged at the bottom in the installation assembly (3).

In another preferred embodiment, the pressure measuring cell (1) with an installation assembly (3) as described herein, wherein at least at the front side, preferably over the entire area, an adhesive layer (5) is arranged between the pressure measuring cell (1) and the bottom (31).

In another preferred embodiment, the pressure measuring cell (1) with an installation assembly (3) as described herein, wherein the adhesive layer (5) comprises silicon adhesive.

In another preferred embodiment, the pressure measuring cell (1) with an installation assembly (3) as described herein, wherein the installation assembly (3) is produced in one piece from metal, preferably from titanium.

In another preferred embodiment, the pressure measuring cell (1) with an installation assembly (3) as described herein, wherein the installation assembly (3) comprises at least at the front side a hard coating and/or a non-stick coating.

In another preferred embodiment, the pressure measuring cell (1) with an installation assembly (3) as described herein, wherein the hard coating is made of silicon carbide or diamond-like carbide.

In another preferred embodiment, the pressure measuring cell (1) with an installation assembly (3) as described herein, wherein the pressure measuring cell (1) is embodied as a ceramic pressure measuring cell.

In another preferred embodiment, the pressure measuring cell (1) with an installation assembly (3) as described herein, wherein the installation assembly (3) is fastened in a process connection (9), preferably welded to said process connection (9).

In another preferred embodiment, the pressure measuring cell (1) with an installation assembly (3) as described herein, wherein the bottom (31) shows a thickness from 0.03 mm to 0.1 mm, preferably approximately 0.05 mm, and/or the adhesive layer (5) a thickness from 0.005 mm to 0.15 mm, preferably approximately 0.02 mm.

In another preferred embodiment, the pressure measuring cell (1) with an installation assembly (3) as described herein, further comprising wherein a circumferential adhesion (7) is arranged between the wall (33) and the pressure measuring cell (1).

In another preferred embodiment, the pressure measuring cell (1) with an installation assembly (3) as described herein, wherein the process connection (9) is produced preferably from titanium.

In another preferred embodiment, the pressure measuring cell (1) with an installation assembly (3) as described herein, wherein, at the rear of the installation assembly, (3) an accepting ring (35) is arranged with a circumferential step (37), which encompasses the pressure measuring cell (1) at the rear in the radial direction.

In another preferred embodiment, the pressure measuring cell (1) with an installation assembly (3) as described herein, wherein the accepting ring (35) is made of metal, preferably titanium.

In another preferred embodiment, the pressure measuring cell (1) with an installation assembly (3) as described herein, wherein the accepting ring (35) and the installation assembly (3) are connected to each other in a fixed fashion, preferably welded.

In another preferred embodiment, the pressure measuring cell (1) with an installation assembly (3) as described herein, further comprising wherein a rear adhesion (8) is arranged between the circumferential step (37) and the pressure measuring cell (1).

### BRIEF DESCRIPTION OF THE DRAWINGS

FIG. 1 is a line drawing evidencing a longitudinal cross-section through an exemplary embodiment of the arrangement according to the invention, and

FIG. 2 is a line drawing evidencing an enlarged detail of the longitudinal cross-section of FIG. 1.

### DETAILED DESCRIPTION OF THE INVENTION

A pressure measuring cell according to the invention comprises an installation assembly with a metal bottom and a circumferential metal wall, with the pressure measuring cell at its front side comprising a measuring membrane, which is arranged at the bottom inside the installation assembly.

By an arrangement of the pressure measuring cell in an installation assembly with a metal bottom and a circumferential metal wall, i.e. in an installation arrangement embodied in a cup-shaped fashion, with the pressure measuring cell and the installation assembly being aligned with the bottom of the installation assembly towards the process, a diffusion-tight unit is created, which can be arranged and/or fastened without any gaskets in a process connection or towards a processing environment. A fastening of the pressure measuring cell without gaskets using the installation assembly in a process connection and/or towards the processing environment can for example be achieved by welding the metal installation assembly in a respective recess of a wall of the processing environment. By welding and a subsequent grinding of the welding seam an absolutely planar arrangement can be generated, free from gaskets, sealed against diffusion, and without any gaps, which is particularly advantageous for the use in processes of the chemical, pharmaceutical, or food industries.

By a sufficiently thin embodiment of the bottom of the installation assembly, here pressures applied thereupon by the processing environment are transferred almost unchanged to the measuring membrane of the pressure measuring cell arranged at the bottom inside the installation assembly so that pressure measurements are still possible without any problems.

An arrangement of the pressure measuring cell in the installation assembly can be achieved in a particularly simple fashion by an adhesive layer embodied between the pressure measuring cell and the bottom of the installation assembly, preferably over the entire area, at least at the front side.

By adhering the pressure measuring cell to the installation assembly, particularly in the area between the measuring membrane and the bottom, a stress-free support of the pressure measuring cell is insured inside the installation assembly, so that particularly thermally induced measuring errors caused by different expansion coefficients between the pressure measuring cell and the installation assembly can be avoided. In case of a sufficiently thin embodiment of the adhesive layer additionally any pressures applied to the bottom of the installation assembly are also transferred without significant loss via the adhesive layer to the measuring membrane of the pressure measuring cell such that still the measuring of pressures is possible without any problems.

Preferably, the thickness of the bottom and the thickness of the adhesive layer are adjusted to each other and to the pressure measuring cell used such that the measuring of pressure is still possible without any problems.

In another embodiment the adhesive layer comprises silicon adhesive. Using highly elastic silicon adhesive, on the one hand, promotes a stress-free support of the pressure measuring cell inside the installation assembly and, on the other hand, ensures a loss-free pressure transfer to the measuring membrane of the pressure measuring cell in case of a sufficiently thin adhesive layer.

The installation assembly can preferably be produced in one piece from metal, preferably from titanium.

A one-piece embodiment of the installation assembly shows the advantage that the installation assembly itself can be embodied without any seams and thus free from stress, i.e. stress introduced for example by welding seams, particularly in the area of the bottom. One embodiment comprising titanium additionally provides the advantage that this material shows heat expansion coefficients differing only slightly from those of ceramic materials, which are frequently used in pressure measuring cells, so that thermal stress caused by this material combination can be avoided.

The use of titanium is also advantageous in that titanium is inert in reference to a plurality of technical processes and thus acts as a diffusion block as well.

In order to achieve additional mechanic improvements of the present invention, it may be provided that a hard coating and/or a non-stick coating is applied at least at its front side, i.e. at the side of the installation assembly facing the process. Such a hard coating may comprise silicon carbide or DLC (diamond-like carbon), for example.

As already mentioned, the pressure measuring cell may preferably be embodied as a ceramic pressure measuring cell, with this being particularly advantageous in combination with an installation assembly made of titanium.

In other material combinations the installation assembly and the pressure measuring cell are preferably adjusted to each other such that they show a thermal expansion coefficient which differs maximally by 15% from each other. This way, any thermally induced measuring errors are largely excluded.

A particularly simple application of the pressure measuring cell with the installation assembly can be yielded when the installation assembly is fastened in a processing connection, preferably welded to said processing connection. By a fastening of the installation assembly in a processing connection a use with common processing connections is possible, for example commonly used threads, with the application of a thread on the fastening assembly not being necessary here, allowing to avoid any stress, particularly in the area of the bottom. In particular, it is not necessary either to provide installation assemblies with different exterior diameters adjusted to the respectively used type of device, because an adjustment occurs via the process connection.

Here too, the welding of the installation assembly to the process connection at the front, due to a subsequent grinding of the welding seam, can result in a planar arrangement, absolutely free from any gaps, so that it is suitable particularly for the chemical, pharmaceutical, and food industries.

In one preferred embodiment the bottom of the arrangement shows a thickness of 0.03 mm to 0.1 mm, preferably amounting to approximately 0.05 mm. The adhesive layer also shows a thickness of 0.005 mm to 0.15 mm, preferably measuring approximately 0.02 mm.

The wall of the installation assembly preferably shows a diameter, which maximally exceeds the diameter of the pressure measuring cell by 5 mm, so that the bottom of the installation assembly, upon the impact of pressure, experiences sufficient bending, which is transferred to the measuring membrane of the pressure measuring cell.

By embodying the bottom with a thickness of approximately 0.05 mm and the adhesive layer with a thickness of approximately 0.02 mm in common pressure measuring cells for a pressure range from 25 mbar to 60 bar and a diameter of the pressure measuring cell of 28 mm sufficiently good transfer of pressure is yielded here via the bottom and the adhesive layer upon the measuring membrane of the pressure measuring cell so that the use of the suggested arrangement is possible without any problems.

A particularly good fastening of the pressure measuring cell in the installation assembly is achieved when additionally a circumferential adhesion is arranged between the pressure measuring cell and the circumferential metal wall. A circumferential, particularly lateral adhesion of the pressure measuring cell to the installation assembly shows the advantage that by the additional fixation in the edge region a more stable arrangement can be achieved as well as a better transfer of the pressures acting upon the front.

In order to minimize thermal stress between the installation assembly and the process connection and additionally to provide an inert overall assembly it may be useful to preferably produce the process connection from titanium. This way, an arrangement can be produced, completely made of titanium towards the process, and thus inert and diffusion tight, which can well be used in otherwise critical processes.

In order to obtain a support of the pressure measuring cell, well protected against the impact of external pressures, and simultaneously generate a unit that can be easily handled, an accepting ring can be arranged preferably at the rear of the installation assembly with a circumferential step, which encompasses the pressure measuring cell at the rear in the radial direction. This way, an arrangement is yielded in which the pressure measuring cell is supported in a mechanically stable fashion inside the combination of the installation assembly and the accepting ring, and simultaneously it is completely protected from external, mechanic influences. As already mentioned repeatedly, in order to avoid any thermal stress between the materials used the accepting ring may also be produced from metal, particularly preferred from titanium.

In order to create an arrangement appearing as a unit towards the outside, the accepting ring is preferably connected fixed to the installation assembly, which can occur preferably by way of welding.

In order to ensure a stress-free support of the pressure measuring cell inside the combination of the installation assembly and the accepting ring, it is useful to arrange a rear adhesion between the circumferential step and the pressure measuring cell. Such a rear adhesion, which preferably is established via highly elastic silicon adhesive, like the adhesive layer and the circumferential adhesion, ensures a completely stress-free support of the pressure measuring cell.

Detailed Description of the Figures

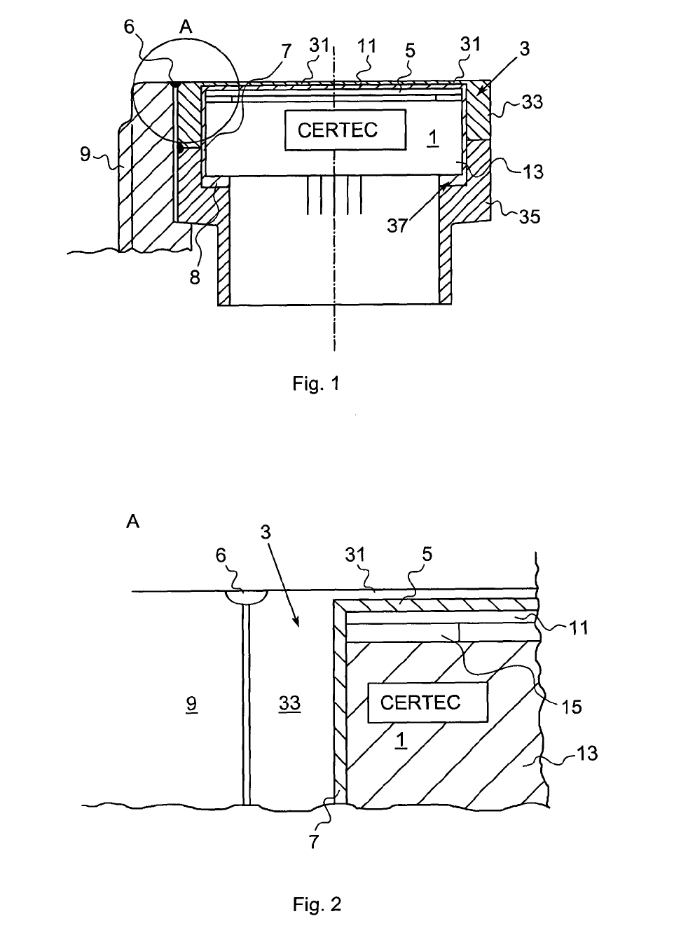

FIG. 1 shows a longitudinal cross-section through an exemplary embodiment of a pressure measuring cell 1, which is arranged in an installation assembly 3. The pressure measuring cell 1 is embodied as an essentially cylindrical capsule, showing a rectangular cross-section in the longitudinal cross-section illustrated in FIG. 1. At a measuring cell body 13, at the front side, a measuring membrane 11 is arranged over a circumferential glass seam 15, which allows for example via condensers formed between the measuring membrane 11 and the basic body 13 via opposite metal coatings a measuring of a force applied via the measuring membrane 11, for example a pressure.

The measuring cell is fastened in the installation assembly 3 via an adhesive layer 5 arranged over the entire area between the measuring membrane 11 and a bottom 31 of the installation assembly 3. The installation assembly 3 comprises additionally a circumferential wall 33, so that the installation assembly 3 overall is embodied in a cup-shaped fashion. In this context it shall be pointed out that the bottom 31 and the adhesive layer 5 are embodied with an extremely low thickness. The bottom 31 shows, for example, a thickness of 0.05 mm and the adhesive layer 5 a thickness of 0.02 mm. The adhesive layer 5 can here be formed, for example, from highly elastic silicon adhesive such that a stress-free support of the pressure measuring cell 1 in the installation assembly 3 is yielded. The installation assembly 3 is welded at the rear to an accepting ring 35, which is embodied with a circumferential step 37, projecting inwardly, which encompasses the pressure measuring cell 1 at the rear in a radial direction. A circumferential adhesion 7 is arranged between the wall 33 of the installation assembly 3 and the pressure measuring cell 1, which holds the pressure measuring cell 1 in the installation assembly 3 free from stress in the radial direction as well. The circumferential adhesion 7 preferably comprises the same highly viscous silicon adhesive the adhesive layer 5 is made of. Additionally, a rear adhesion 8 is provided between the accepting ring 35, particularly between its section extending radially towards the pressure measuring cell 1 and the circumferential step 37, which encompasses the pressure measuring cell 1 at the rear in the radial direction. By this rear adhesion 8 it is ensured that the pressure measuring cell 1 is also supported free from pressures in the axial direction.

The accepting ring 35 is welded circumferentially to the installation assembly 3 such that after grinding the welding seam here an arrangement is formed that can be handled separately.

In the present exemplary embodiment, at the front, the installation assembly 3 is welded circumferentially in a process connection 9, which may show an external thread, for example. The process connection 9 is embodied corresponding to the combination of installation assembly 3 and accepting ring 35 and welded at the front circumferentially to the installation assembly 3. After the welding seam 6 has been ground, here at the front side an absolutely planar, diffusion tight coupling to a process environment is ensured, free from any gaps.

FIG. 2 shows an enlarged detail of FIG. 1.

The enlarged detail shown in FIG. 2 illustrates particularly clearly the adhesive layer 5, arranged between the bottom 31 and the measuring membrane 11, which without any transition continues in the laterally extending, circumferential adhesion 7 between the wall 33 and the measuring cell body 13 of the pressure measuring cell 1. Due to the fact that, as shown in the exemplary embodiment, the bottom 31 and the adhesive layer 5 are embodied in a thickness which is approximately equivalent to the thickness of the measuring membrane 11, an excellent transfer of pressures applied at the front upon the bottom 31 is ensured here via the adhesive layer 5 upon the measuring membrane 11. In particular, due to the fact that the bottom 31 shows a radius which is only slightly greater than an exterior diameter of the pressure measuring cell 1, it is ensured that any bending of the bottom 31, particularly in a central section, i.e., in a section distanced from the circumferential wall 33, is transferred directly to the measuring membrane 11.

In the enlarged detail shown in FIG. 2 the circumferential welding seam 6 between the installation assembly 3 and the process connection 9 is also illustrated particularly clearly. As discernible from FIG. 2, the welding seam 6 is ground at the front side, so that a face of the assembly is yielded free from gaps and elevations. This is particularly advantageous for applications in the food sector, because in such applications any deposits in potentially present gaps must be avoided.

In a preferred variant of the embodiments the installation assembly 3, the accepting ring 35, and the process connection 9 are all made of titanium. The use of titanium as the material ensures, on the one hand, high diffusion tightness of the suggested arrangement, and on the other hand, high chemical inactivity (inertness) of the arrangement towards many processes.

### LIST OF REFERENCE NUMBERS

1 Pressure measuring cell
3 Installation assembly
5 Adhesive layer
7 Adhesion
8 Rear adhesion
9 Process connection
11 Measuring membrane
13 Measuring cell body
15 Glass seam
31 Bottom
33 Wall
35 Accepting ring
37 Circumferential step

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A pressure measuring cell comprising an installation assembly with a metal bottom and a circumferential metal wall, with the pressure measuring cell at the front side comprising a measuring membrane, which is arranged at the bottom in the installation assembly.

2. The pressure measuring cell with an installation assembly of claim 1, wherein at least at the front side, preferably over the entire area, an adhesive layer is arranged between the pressure measuring cell and the bottom.

3. The pressure measuring cell with an installation assembly of claim 1, wherein the adhesive layer comprises silicon adhesive.

4. The pressure measuring cell with an installation assembly of claim 1, wherein the installation assembly is produced in one piece from metal, preferably from titanium.

5. The pressure measuring cell with an installation assembly of claim 1, wherein the installation assembly comprises at least at the front side a hard coating and a non-stick coating.

6. The pressure measuring cell with an installation assembly of claim 5, wherein the hard coating is made of silicon carbide or diamond-like carbide.

7. The pressure measuring cell with an installation assembly of claim 1, wherein the pressure measuring cell is embodied as a ceramic pressure measuring cell.

8. The pressure measuring cell with an installation assembly of claim 1, wherein the installation assembly is fastened in a process connection, preferably welded to said process connection.

9. The pressure measuring cell with an installation assembly of claim 1, wherein the bottom shows a thickness from 0.03 mm to 0.1 mm, preferably approximately 0.05 mm, and/or the adhesive layer a thickness from 0.005 mm to 0.15 mm, preferably approximately 0.02 mm.

10. The pressure measuring cell with an installation assembly of claim 1, that further comprising wherein a circumferential adhesion is arranged between the wall and the pressure measuring cell.

11. The pressure measuring cell with an installation assembly of claim 8, wherein the process connection is produced from titanium.

12. The pressure measuring cell with an installation assembly of claim 1, wherein, at the rear of the installation assembly, an accepting ring is arranged with a circumferential step, which encompasses the pressure measuring cell at the rear in the radial direction.

13. The pressure measuring cell with an installation assembly of claim 13, wherein the accepting ring is made of metal, preferably titanium.

14. The pressure measuring cell with an installation assembly of claim 13, wherein the accepting ring and the installation assembly are connected to each other in a fixed fashion, preferably welded.

15. The pressure measuring cell with an installation assembly of claim 12, that further comprising wherein a rear adhesion is arranged between the circumferential step and the pressure measuring cell.
